(19) United States
(12) Patent Application Publication
(10) Pub. No.: US 2021/0049239 A1
(43) Pub. Date: Feb. 18, 2021

(54) MULTI-LAYER DOCUMENT STRUCTURAL INFO EXTRACTION FRAMEWORK

(71) Applicant: Microsoft Technology Licensing, LLC, Redmond, WA (US)

(72) Inventors: Ziliu LI, Bellevue, WA (US); Catalin Teodor MILOS, Bellevue, WA (US); Junaid AHMED, Bellevue, WA (US); Arnold OVERWIJK, Redmond, WA (US); Cheng LU, Kirkland, WA (US); KwokFung TANG, Bellevue, WA (US); Matthew HURST, Seattle, WA (US)

(73) Assignee: Microsoft Technology Licensing, LLC, Redmond, WA (US)

(21) Appl. No.: 16/542,845

(22) Filed: Aug. 16, 2019

(51) Int. Cl. G06F 17/27; G06F 16/93; G06N 20/00

(52) U.S. Cl. CPC G06F 17/2785; G06N 20/00; G06F 16/93; G06F 17/2705

(57) ABSTRACT

Configurations herein comprise a multi-layer framework to extract document structural data. The framework extracts structural data from raw, unstructured, electronic documents, for example, .pdf documents. Structural data refers to the semantic elements, for example, paragraphs, lists, tables, titles etc. that may be visible in the displayed document but not described in electronic data.

### BACKGROUND

Some applications, for example, search services can use the structure of a document to help in providing results. Unfortunately, some documents, for example, .pdf documents often do not contain structure information. There are several challenges in extracting such document structural information: reconstructing the structure information from the data can actually lose the structure; document properties, for example, multiple columns in one page can cause issues; cross page content, for example, a list or table that crosses multiple pages, can be difficult to ascertain; and nested content, for example, a list that contains a list or a table, a table that contains a list or a table, etc. can be difficult to determine. Thus, determining a document's structure can be a challenge.

### SUMMARY

Configurations herein comprise a multi-layer framework to extract document structural data. The framework extracts structural data from raw, unstructured, electronic documents, for example, .pdf documents. Structural data refers to the semantic elements, for example, paragraphs, lists, tables, titles etc. The multi-layer framework deploys two or more machine learning (ML) models to ascertain elements or structures within the document. Each subsequent ML model may evaluate the output of one or more of the previous ML models. The ML models build upon the determinations of previous models to ascertain the higher level structures in the document, the location of the structures, the relationships of the various structures, and other information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates a first system diagram in accordance with aspects of the present disclosure;

FIG. 2A illustrates a block diagram of a document structure service in accordance with aspects of the present disclosure;

FIG. 2B illustrates another block diagram of a document structure service in accordance with aspects of the present disclosure;

FIG. 3 illustrates a data structure representing data or signals sent, retrieved, or stored by a virtual assistant in accordance with aspects of the present disclosure;

FIG. 4 is another data structure representing data or signals sent, retrieved, or stored by a virtual assistant in accordance with aspects of the present disclosure;

FIG. 5A illustrates a visual representation of document being analyzed by a layer in accordance with aspects of the present disclosure;

FIG. 5B illustrates a visual representation of document being analyzed by a layer in accordance with aspects of the present disclosure;

FIG. 5C illustrates a visual representation of document being analyzed by a layer in accordance with aspects of the present disclosure;

FIG. 5D illustrates a visual representation of document being analyzed by a layer in accordance with aspects of the present disclosure;

FIG. 5E illustrates a visual representation of document being analyzed by a layer in accordance with aspects of the present disclosure;

FIG. 6 illustrates a method, conducted by a document structure service, for training a machine learning model in accordance with aspects of the present disclosure;

FIG. 7 illustrates a method, conducted by a document structure service, for determining the structure of an unstructured document in accordance with aspects of the present disclosure;

FIG. 8 is a block diagram illustrating example physical components of a computing device with which aspects of the disclosure may be practiced;

FIG. 9A is a simplified block diagram of a computing device with which aspects of the present disclosure may be practiced;

FIG. 9B is another are simplified block diagram of a mobile computing device with which aspects of the present disclosure may be practiced;

FIG. 10 is a simplified block diagram of a distributed computing system in which aspects of the present disclosure may be practiced; and

FIG. 11 illustrates a tablet computing device for executing one or more aspects of the present disclosure.

In the appended drawings, like numerals represent like components or elements.

### DETAILED DESCRIPTION

Aspects herein comprise a multi-layer framework to extract documents structural data. The framework extracts structural data from unstructured, electronic documents. An unstructured document is an electronic document that has visual structure provided in the user interface but no metadata or other data that describes such structure electronically. Structural data refers to semantic elements such as paragraphs, lists, tables and titles etc. in documents. Currently, most existing solutions use rule-based methods, which can fail to collect the structure data accurately and may perform poorly across documents of different types.

The framework is machine learning based, and consists of multiple layers. Each layer can deploy a different ML model that may have a different extraction focus for each of the different layers. The lower or lowest layer can focus on syntax information, while the higher layer(s) can use the output from the lowest/lower layers to focus on structure semantics.

As an example, the framework can include four layers, although there may be more or fewer layers depending on the environment's requirements and conditions. The first layer, of the example four layer framework, can be the region identifier, which can focus on identifying the different, granular pieces data from the document, e.g., words, punctuation, phrases, titles, captions, etc.

The second layer can focus on higher level aggregation of structures that can be based on the results or output from the first layer. For example, the second layer may determine sentences, titles, captions, headers, footers, endnotes, etc. The second layer or subsequent layers can embed the unstructured document with document level features. The second layer or subsequent layers may then output structural information for extraction and identification.

Different types of semantic structural identification can be performed in parallel. For each type of structural data, there may be a region candidate generator and classifier. The region candidate generator can generate candidate structures for the given input unstructured document. The candidate structures can be used as training data for the ML model(s) to extract features and train the structure model. The generator can output candidates for prediction during the document extraction/conversion.

The classifier can be trained to determine whether a candidate has a target structural type. The classifier may be a unified multiple classes classifier or a multiple binary classifiers (one for each type of structural data). For training, a labeling tool can provide users with a convenient user interface to label regions within the unstructured document, and then input the labeled document to train the generators and classifiers. The labeled regions can serve as training data for the generators and classifiers, but the actual structures to be trained are flexible and can be customized.

A third layer can detect and generate the internal relationship(s) of the structures. The relationship parser can parse the structural data to output a self-contained structural representation of the document. The relationship parser can analyze the output of the second layer and/or other document information (e.g., layout, markup, metadata) to parse the data into the structural element. The output of the third layer or subsequent layers can be represented as tree-like structure.

The fourth layer, in this example, may be the top level layer and can blend the elements and/or reconstruct the structures into high-level nested relationship(s) that may develop or organize the semantic meaning in the document. The fourth layer may identify and record the cross-page structures and nested structures. A merge may be performed by the fourth layer to develop the complete tree data structure. Different trees can represent different types of semantic elements, for example, paragraphs, lists, tables, etc. In the fourth layer, a merge can conflate the separate semantic elements from the different trees into the corresponding location and output one virtual tree. In the tree, the semantic elements can be represented as virtual nodes, and the virtual node might cross multiple pages in the document.

Currently, there is no good solution/product to extract the semantic structural information from unstructured documents, e.g., .pdf documents. With the framework here, developers can easily include different algorithms/libraries to extract different kinds of semantic documents in parallel. What is more, the framework can provide a good way to blend different kinds of documents into one unified representation and keep the neighbor information, which can allow the user to continue to output higher level semantic documents. Additionally or alternatively, the framework can help resolve the cross page and nested issues more comprehensively and elegantly. Finally, the tree diagram output can then be used by other processes.

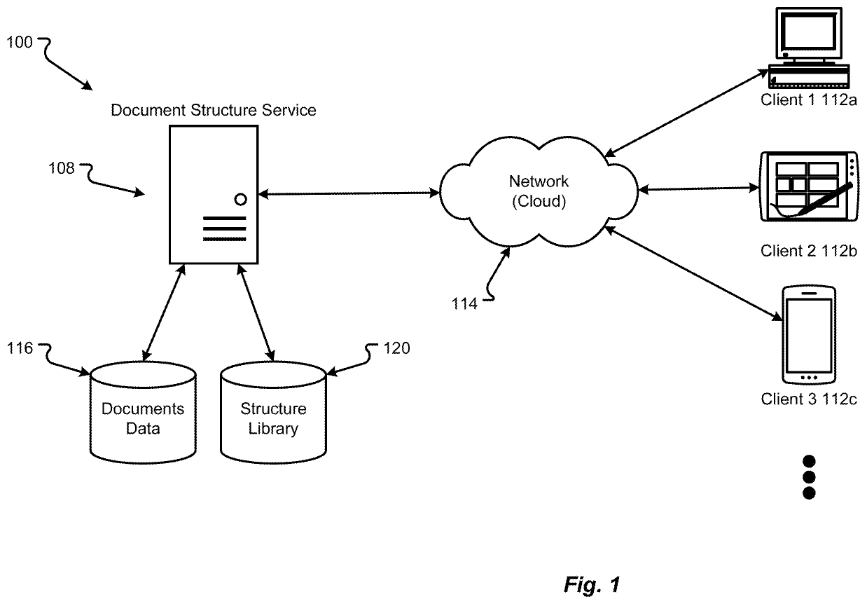

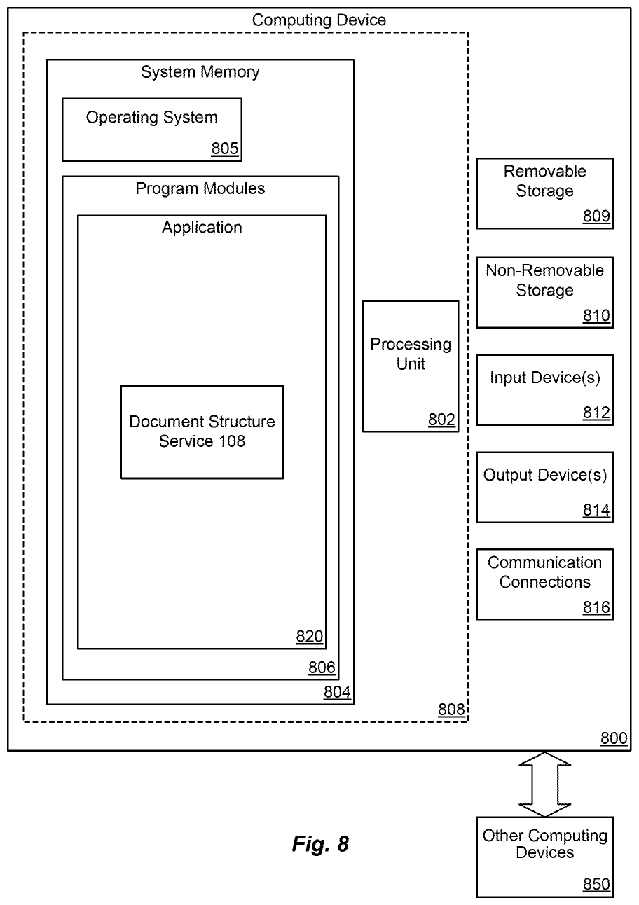

A system 100 for determining structural attributes about a document may be as shown in FIG. 1. A document structure service 108 (for example, executing in a cloud server) may be in communication with one or more clients 112a, 112b, and/or 112c. The document structure service 108 and/or client(s) 112 may each embody or execute on a computing system or device, as described hereinafter in conjunction with FIGS. 8-11. Hereinafter, the document structure service 108 may be used to represent all of the types of cloud computing systems or applications that provide a service to assist in the determination of structure in an unstructured document.

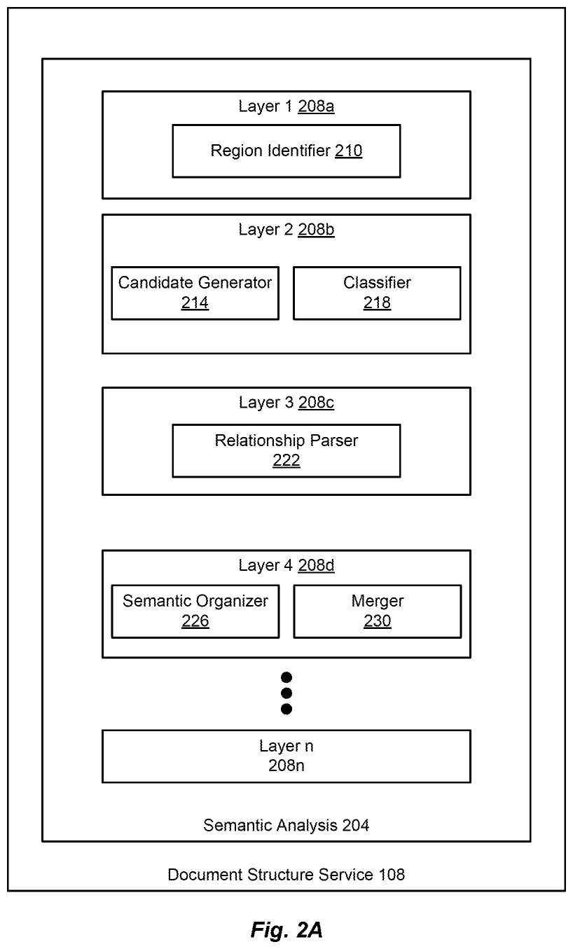

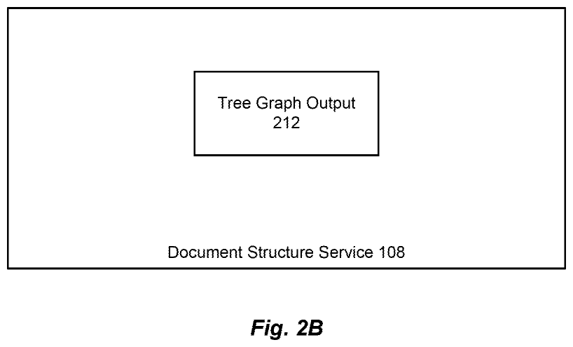

The document structure service 108 can include any hardware, software, or combination of hardware and software associated with a server, as described herein in conjunction with FIGS. 8-11. It should be noted that the document structure service 108 and the client 112 may execute portions of an application to evaluate documents. An example of the document structure service 108 may be as described in conjunction with FIGS. 2A and 2B.

The system 100 can also include one or more clients 112 that may be in communication with the document structure service 108 over the network 114. The client 112 can be any hardware, software, or combination of hardware and software associated with any computing device, mobile device, laptop, desktop computer, or other computing system, as described herein in conjunction with FIGS. 8-11. The client 112 can provide input, e.g., unstructured documents, to the document structure service 108 or receive the output of the document structure service 108, e.g., the document structure information.

The document structure service 108 may communicate with the client 112 through a network 114 (also referred to as the “cloud”). The term “document structure service 108” can imply that at least some portion of the functionality of the document structure service 108 is in communication with the client 112. The network 114 can be any type of local area network (LAN), wide area network (WAN), wireless LAN (WLAN), the Internet, etc. Communications between the document structure service 108 and the client 112 can be conducted using any protocol or standard, for example, TCP/IP, JavaScript Object Notation (JSON), Hyper Text Transfer Protocol (HTTP), etc. Generally, commands or requests associated with analyzing a document are routed to the document structure service 108 for processing. The document structure service 108 may be in communication with, have access to, and/or include one or more databases or data stores, for example, the documents data store 116 and/or the structure library data store 120.

The data stores 116 and 120 can be any data repository, information database, memory, cache, etc., which can store documents and/or document structures provided to or generated by the document structure service 108. The data stores 116/120 can store the information in any format, structure, etc. on a memory or data storage device, as described in conjunction with FIGS. 8-11. Generally, the document data 116 includes the content, metadata, and/or other information about the document provided to the document structure service 108 and can include one or more of, but is not limited to, content within an electronic document (e.g., text, pictures, video, audio, etc.), metadata (e.g., type of document, subject, author, title, date of publication, source of publication, time when document is provided, locations of document (e.g., Uniform Resource Locator(s) (URLs), etc.) where the various documents are stored, etc.), and/or other information that may be specific to the document(s) provided by or to the document structure service 108. It should be noted that documents will be described herein, but the aspects herein may apply to other types of content or content structures.

The structure library 120 can include information or machine learned document structures, associated with documents provided to the document structure service 108, which may be provided to the client 112 to allow the client 112 to understand a document. For example, the structure library 120 can include one or more structures generated on similar documents to that provided to the client 112. The provided structure from the structure library 120 can allow other applications to use the structure data for other purposes, for example, improved searching. Further, the structure library 120 may store metadata or other information about the structures. The metadata or other information can include one or more of, but is not limited to, the document associated with the structure, the configuration of the document, the author, the configuration of the application or software used to create the document, etc.

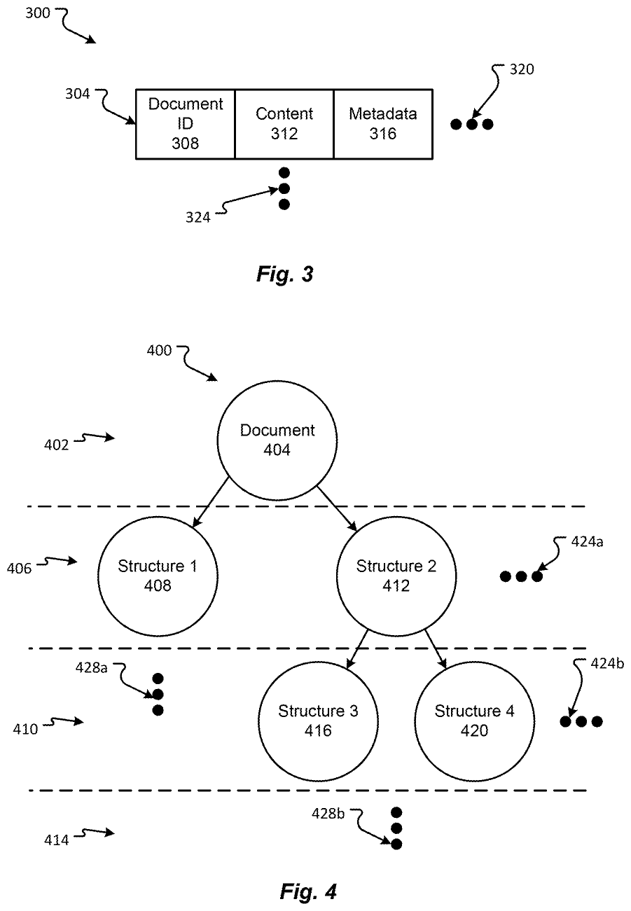

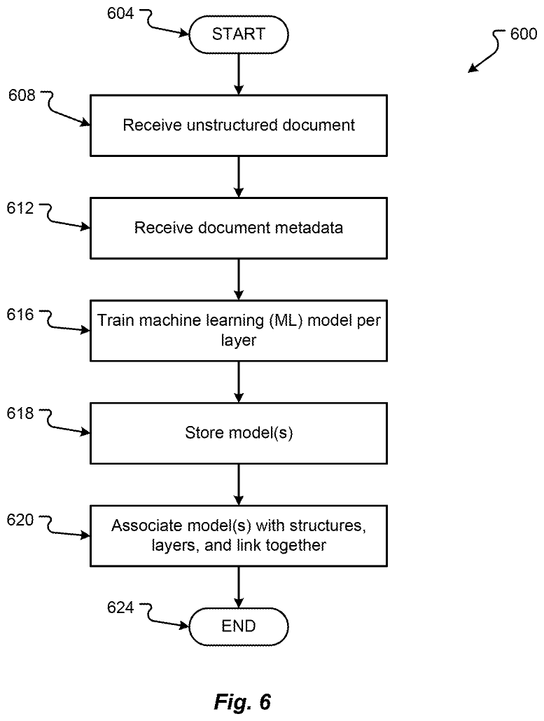

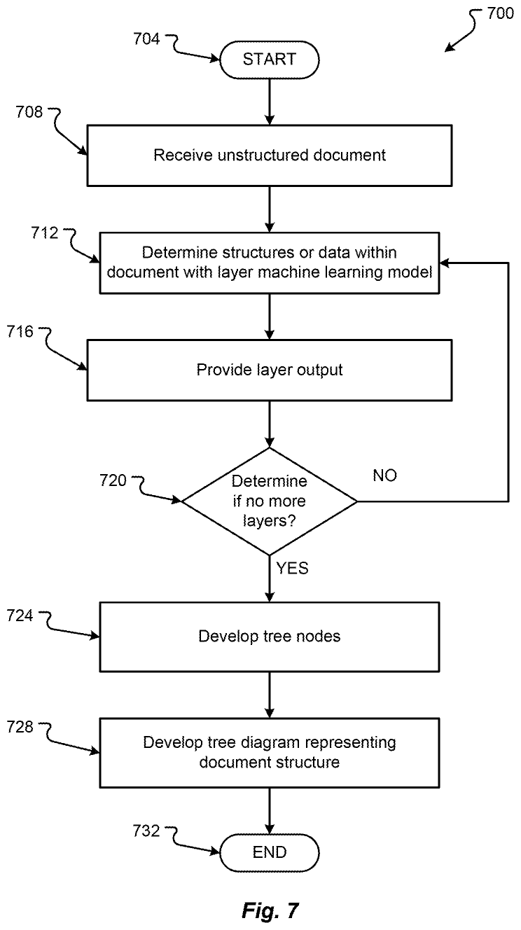

The client 112 can retrieve or have provided the document and/or the structures from one or more of the data stores 116, 120. Then, the client 112 can review the document, possibly using the structure to improve the quality of the review of the document, to the user interface of the client device. The process for determining a structure associated with a document may be as described in conjunction with FIGS. 6-7. The data stored, retrieved, or exchanged between components 108, ad/or 112 may be as described in conjunction with FIGS. 3, 4.

An example configuration of a document structure service 108 may be as shown in FIGS. 2A and 2B. The document structure service 108 may include one or more of, but is not limited to, a semantic analysis component 204 and a tree graph output 212. Each of the components 204, 212 can be executed in one or more computer systems. Thus, one component may be executed in a first computer system and another component may be executed on another computer system. The various components 204, 212 can provide a semantic structure from an unstructured document. Each of the components 204 through 230 may be hardware, software, or hardware and/or software.

A semantic analysis component 204 can train a machine learning (ML) model for a convolution neural network (CNN). The semantic analysis component 204 may then apply the ML model to determine a structure of an unstructured document. The semantic analysis component 204 can receive, from the client 112, the document and/or metadata associated with the document. From the document and metadata, the semantic analysis component 204 can create at least one ML model associated with that type of document. The ML model may then be used to determine a document structure for documents that may be delivered to the client 112 or used in another application. As such, the semantic analysis component 204 can train models for various types of documents, where those models are specific to the type of document, the metadata, and/or the user needs. These generated models may be stored in the structure library 120.

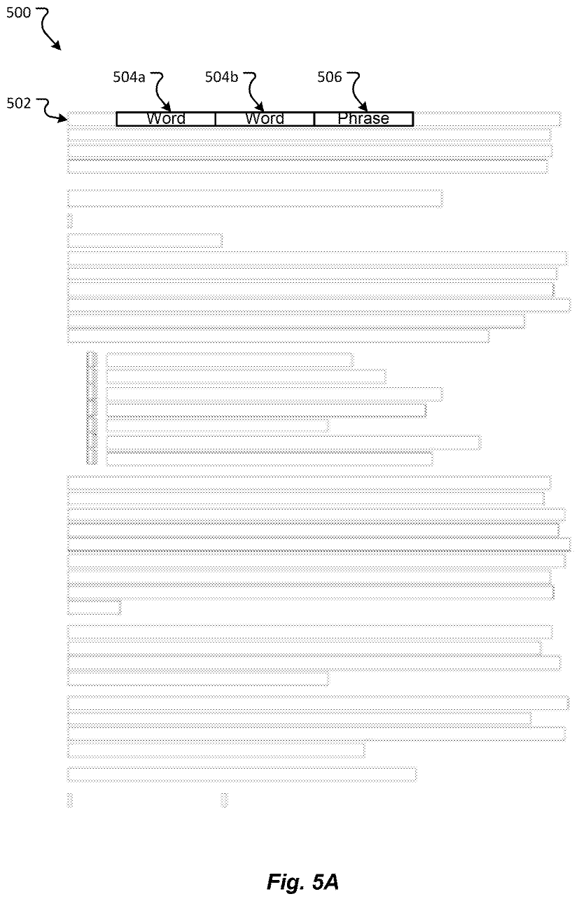

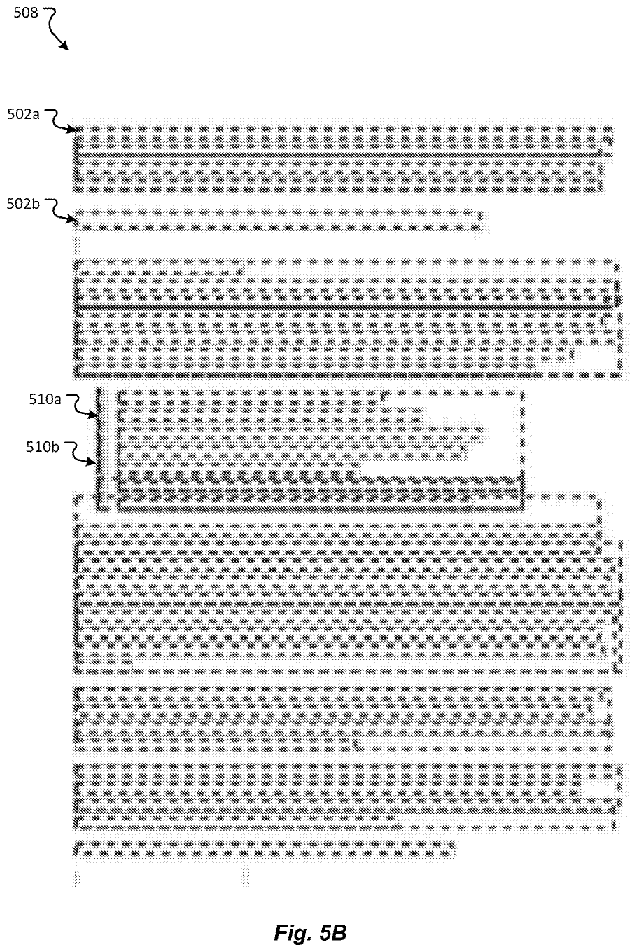

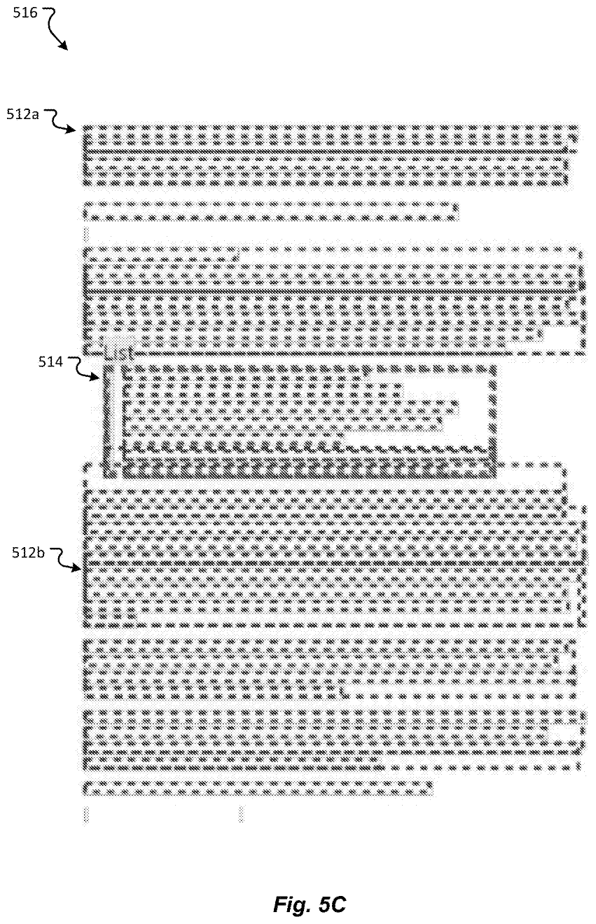

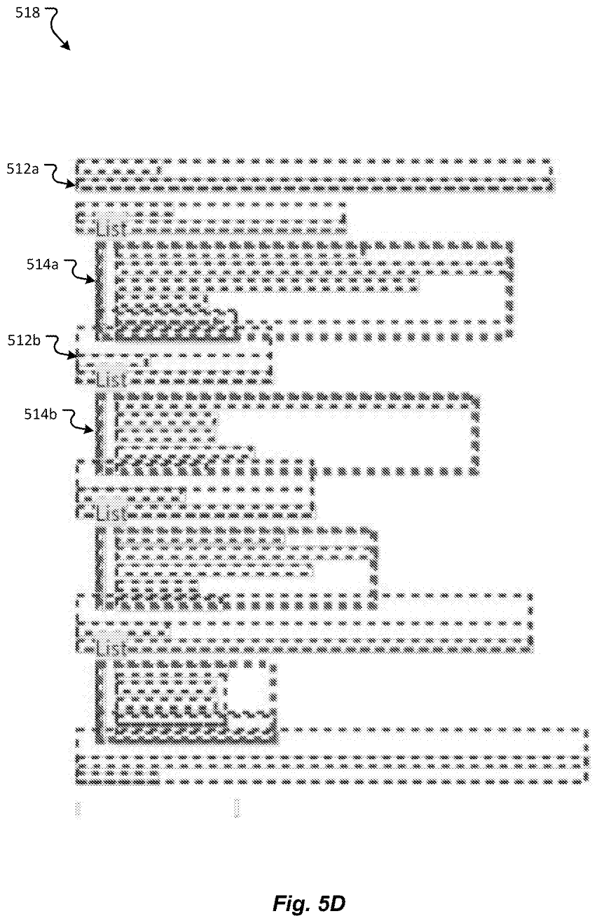

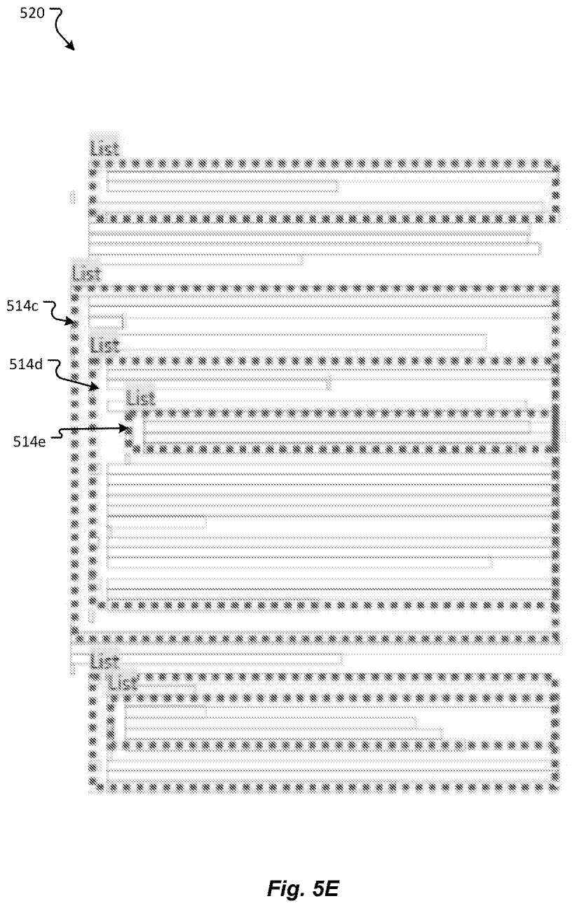

The semantic analysis component 204 can comprise one or more layers 208a-208n that can analyze different parts of the document. A first layer 208a may evaluate only a portion of the information associated with the document. Then, a second layer 208b or subsequent layers may develop information from the results of the analysis of the first layer 208a or previous layers. Thus, each layer 208b-208n develops further information from the result of the higher layers 208a, 208b, etc. An example four layer analysis may be as described in conjunction with FIGS. 5A-5E. It should be noted that there is no set number of layers needed to determine the structure of the document, and the four layer configuration is only exemplary.

In the exemplary four layer framework, a first layer 208a can include a region identifier 210 to identify elements (e.g., a sentence, a word, a punctuation, a space, a page break, and a phrase, etc.) in the unstructured document. The operation of the region identifier 210 may be as explained in conjunction with FIGS. 3-7. In a second layer, a candidate generator 214 can also identify elements (e.g., a paragraph, a list, a table, a sentence, a word, a punctuation, a space, a page break, and a phrase, a hyperlink, a multimedia object, a chart, a graph, a caption, a link to other content, a pointer to other content or to another file, a picture, a video, a title, etc.), also referred to as structure candidates, and a classifier 218 can classify the type of structure for the candidates. The operation of the candidate generator 214 and classifier 218 may be as explained in conjunction with FIGS. 3-7. A third layer 208c can include a relationship parser 222 that can identify and categorize nodes, representing structures, and link sets of nodes together to indicate relationships between those structures. The operation of the relationship parser 222 may be as explained in conjunction with FIGS. 3-7. A fourth layer 208d can include a semantic organizer 226 that organizes the structure candidates and relationships from the second layer 208b and the third layer 208c and a merger 230 that can form structure candidates into a single document structure file representing the structure of the document.

The document structure file can be an electronic data output that can be provided back to the client or to other applications for further process by the client or the other applications. The document structure file can also be a separate data file from the original unstructured document, which may be linked thereto, or can be a separate portion of the metadata of the unstructured document that is associated or stored with the unstructured document. A type of document structure file can include a tree graph, which is provided as an example below. The operation of the semantic organizer 226 and merger 230 may be as explained in conjunction with FIGS. 3-7.

A determined structure may be output by a tree graph output 212. The tree graph output 212 can generate a nodal tree graph output, for another party or application, to describe the structure of the document. An example of the tree graph output can be as described in conjunction with FIG. 4. The tree graph provides a sematic, relational description of the structures in the document for future analysis. The tree graph is only one type of output possible but other outputs that describe the document structure can also be provided.

The tree graph can also be associated with the metadata of the document by the tree graph output 212. The determined association can be a link or pointer to the structure and/or document, based on the document type or other information, in the structure library 120. The structure association may be based on metadata associated with the document. If a document has similar metadata to the document having a determined structure, then the structure model(s) may also be associated with that new document. The type of metadata that may be associated with the structure can include one or more of, but is not limited to, the content of the document, the type of document, the author, the publisher, a character in the document, where the document is being published, or other types of metadata.

The tree graph output 212 can also store or retrieve models or structures in the structure library 120. The tree graph output 212 can conduct interactions with or interface with any type of database, for example, flat file databases, file systems, hierarchical databases, nodal databases, relational databases, etc. To store or retrieve structures, the tree graph output 212 can receive information from the client 112 to retrieve a structure from the structure library 120 or to store a structure to the structure library 120. Thus, any information required to retrieve or store structures, within the structure database 120, may be provided by tree graph output 212. Further, the client 112 may provide the information for the structure to be stored in the structure library 120. Thus, the client 112, in some configurations, can create structures or portions of structures for and store structures into the structure library 120.

Configurations of data and data structures 300 and 400 that can be stored, retrieved, managed, etc. by the system 100 may be as shown in FIGS. 3 and 4. The data structures 300, 400 may be part of any type of data store, database, file system, memory, etc. including object-oriented databases, flat file databases, file systems, etc. The data structures 300, 400 may also be part of some other memory configuration. The databases, signals, etc. described herein can include more of fewer data structures 300, 400 than those shown in FIGS. 3 and 4, as represented at least by ellipses 324, 428.

The data structure 304, shown in FIG. 3, can represent the data in the documents data store 116 managed by the document structure service 108. The data structure 304 can include one or more of, but is not limited to, a document identifier (ID) 308, a content 312, and/or metadata 316. There may be more or fewer data fields in data structure 304, as represented by ellipses 320. Each document can include a data structure 304 in the data structures 300. There may be more data structures 304 in the system 100, as represented by ellipses 324.

The document ID 308 can include any type of information that can uniquely identifies the document received by the document structure service 108. Thus, the document ID 308 can include an Internet Protocol (IP) address, an address or identifier of the client 112, a numeric ID, a uniform resource locator (URL), an alphanumeric ID, a globally unique ID (GUID), etc.

The content 312 can comprise the contents of the document. For example, in an electronic document, the content 312 can include one or more of, but is not limited to, text, pictures, embedded objects, video, audio, graphs, lists, paragraphs, tables, presentation slides, etc. The content 312 may not include structure information that describes the format of the document.

The metadata 316 can include information about the document. The metadata 316 can include descriptions or classifications of the document. The metadata 316 may include one or more of, but is not limited to, one or more items of information 414 about the document, the type of document, the length of the document, the author, the publisher, the location of the document, the type of document, the subject of the document, key words in the document, etc. In some configurations, the tree diagram or structure information generated about the document may be stored or embedded in the document as metadata 316. In other configurations, the metadata 316 can include a link or pointer to the structure information.

The type of document can include any type of identification of what type of subject or format of the document. Thus, the type of document can include financial, medical, search document, social media, etc. The type of document can also include subtypes of different content. For example, if the document is a financial document, the type of document can be a balance sheet, a quarterly statement, etc. Thus, the type of document information includes any information needed by the document structure service 108 to associate a structure with the type of document about to be received. In this way, the document structure service 108 can recommend or send a structure to the client 112 if the client 112 desires.

A configuration of a data structure file 400, which may represent electronic data or an electronic data described document structures within an unstructured document, may be as shown in FIG. 4. The data structure 400 represents a tree diagram having multiple levels, for example, levels 402, 406, 410, 414, etc. The tree 400 is formed from one or more nodes 404, 408, 412, 416, 420, etc., in each level 402-414. A top node 404 can represent the document. Each lower node 408-420 in the document can represent some type of structure in the document. For example, the nodes 408-420 can represent the document, paragraphs, lists, tables, words, sentences, pictures, graphs, etc. The form of the tree 400 embodies the structure of the document. A child node is associated with the parent node and may be nested or subordinate to the patent node, which can indicate the structures represented are nested or subordinate. For example, a node 416 may be an item in a list, represented by node 412, in the document 404, which indicated the item is subordinate to the list.

Each node 408-420 can also include information about the structure. For example, the node 408-420 can include one or more of, but is not limited to, a node identifier, a structure type, identifier to the parent and/or child nodes, the content within the structure, etc. The node identifier can be any type of identifier, including a numeric, alphanumeric, GUID, etc. The structure type can include a type of structure in the document, for example, a paragraph, a list, a table, a sentence, a word, a punctuation, a space, a page break, and a phrase, a hyperlink, a multimedia object, a chart, a graph, a caption, a link, a pointer, a picture, a video, a title, etc. The identifier to the parent/child nodes can be any identifier of the other node, a link to the other node, etc. There may be more or less information stored with each node.

User interfaces or stages of analysis by the document structure service 108 may be as shown in FIGS. 5A-5E. The several FIGS. 5A through 5D represent the analysis that may be conducted by four layers 208 of the semantic analysis component 204. It should be noted that there may be more or fewer layers in the analysis. With a first layer 208a analysis, as represented in FIG. 5A, the region identifier 210 comprises a first ML model that may parse and analyze the granular components of the document. For example, the region identifier 210, as a first ML model, can identify sentences 502 or other components of the document and parse those portions into words 504a and 504b, punctuation, phrases 506, etc. These portions of the document can then be analyzed for content, syntax, sentiment, etc. The output of the region identifier 210 ML model may then be provided to the second layer 208b, as represented in FIG. 5B.

The candidate generate 214, comprising a second ML model associated with the second layer 208b, can receive the output of the first layer 208a. From the output, the region identifier 210 can determine a higher level structure(s) in the document, as represented in document 508, in FIG. 5B. The region identifier 210 may parse and analyze the components of the output from the first layer 208a to determine the presence of sentences, listed items, captions, footnotes, headers, endnotes, etc. For example, the region identifier 210 can identify sentences 502a and 502b. Further, the region identifier 210 can identify list items 510a and 510b. The classifier 218, which may include another ML model or be a separate function of the second layer 208b ML model, can classify or label the determined structures. Thus, the candidate generator 214 locates the structures and the classifier 218 determines what each located structure is, e.g., a sentence, a paragraph, a list, a table, etc. These located and classified higher level structures then form the output of the second layer 208 that can be sent to a third layer 208c.

The relationship parser 222 can include a third ML model, associated with a third layer 208c, to receive the output of the second layer 208b. From the second layer's output, the third layer 208c can determine a higher level structure(s) in the document from that determined by the second layer 208b and/or identify the relationships between the structures identified by the second layer 208b, as represented in document 516 in FIG. 5C. The relationship parser 222 may parse and analyze the components of the output from the second layer 208b to determine the relationships or associated of paragraphs 512a and 512b, lists 514, pictures, multimedia content, sections, table of contents, tables, equations, etc., in the document. Each structure can be formed into a node. Sets of nodes may be combined into branches of tree. In this way, the several relationships between parts of the document are indicated. A branch with child nodes can indicate subordinate or nested structures. The output of the third layer 208c can represent the higher or highest level structures and the relationships between those structures. There may be more layers 208 that can continue to process the document. These highest level structures and relationships then form the output of the third layer 208 that can be sent to a fourth layer 208d.

The semantic organizer 226 can employ a fourth ML model, associated with a fourth layer 208d, and can receive the output of the third layer 208c. From the third layer's output, the semantic organizer 226 can determine relationships and organize the higher level structure(s) and branches determined and generated by the third layer 208c, as represented in document 518 in FIG. 5D and/or document 520 in FIG. 5E. The semantic organizer 226 208d may determine a location of the higher level structures and a proximal and/or structural relationship between the structures or sets of structures identified by the relationship parser 222. From this information, the merger 230 can generate the tree data structure 400 that represents the document 518, 520. Thus, the merger 230 can determine the overall document relationships and orientation of the paragraphs 512a and 512b, lists 514, pictures, multimedia content, sections, table of contents, tables, equations, etc. The output of the merger 230 can represent the structure of the document that may be provided to the client 112 or other applications and/or users.

As shown in FIG. 5D, the document 518 may represent the first node 404. A paragraph 512a may represent a second node 412, and a list 514a can represent a third node 416. The second node 412 can be a sub-node or a child node of the higher node 404 and represent a higher level structure in the document 518. The placement of the nodes in the tree diagram can represent location, for example, node 408, being on the left, may be higher in the document that node 412. A child node, for example, node 416, may be nested or represent a structure that is dependent on or subordinate to another structure, for example, node 412. In the document 518, nested list 514a may be subordinate to the paragraph 512a.

In another example of a document 520 shown in FIG. 5E, an alternative representation of structure is provided. The lowest level structure, for example, the list 514e can be a lowest node 420. The next structure above the list 514e can also be represented as a list 514d, which may be a higher level node, e.g., 412. Then, the higher level structure 514c can be an even higher node, but still identified as a list due to the higher level structures relationship with the list. A paragraph can be also represented by a similar set of nodes in a descending relationship. For example, another branch may include a paragraph 514d (structure 514d can represent a list and a paragraph) as a node 416 and another paragraph 514c may be node 412. In this way, separate type of structure can be represented with the locations and dependencies defined. The relationship parser 222 can create these smaller branches, and the semantic organizer 226 can indicate the location for the branches in the tree generated by the merger 230.

A method 600, as conducted by the document structure service 108, for training an ML model for one or more of the layers 208 may be as shown in FIG. 6. A general order for the steps of the method 600 is shown in FIG. 6. Generally, the method 600 starts with a start operation 604 and ends with an end operation 624. The method 600 can include more or fewer steps or can arrange the order of the steps differently than those shown in FIG. 6. The method 600 can be executed as a set of computer-executable instructions executed by a computer system and encoded or stored on a computer readable medium. Further, the method 600 can be performed by gates or circuits associated with a processor, an application specific integrated circuit (ASIC), a field programmable gate array (FPGA), a system-on-chip (SOC), or other hardware device. Hereinafter, the method 600 shall be explained with reference to the systems, components, devices, modules, software, data structures, interfaces, methods, etc. described in conjunction with FIGS. 1-5 and 7-11.

The document structure service 108 may receive document, in step 608. The document, which may be for example similar to a document 500, which may be received from the client 112, provided by a third party, or retrieved from data store 116. If received, the document may be stored in the documents data store 116. Thereinafter, the document can be provided to the document structure service 108 to train the one or more ML models associated with layers 1 208a, layer 2 228b, layer 3 288c, layer four 228d, and/or layer n 208n.

Further, the document structure service 108 can also receive document metadata associated with the document, in step 612. The document metadata may also be received from the client 112, from a third-party, retrieved from the data store 116, etc. The metadata can include various information about the document received in step 608. The document metadata can include one or more of, but is not limited to, the author, the date of creation, the number of words, the sentiment, the environment (e.g., accounting, call center, legal office, etc.) in which the document was created, the document type, etc. The metadata may also be stored in documents data store 116 by the document structure service 108. Thereinafter, the document metadata may be provided to the semantic analysis component 204 to train the ML models associated with layers 208.

The semantic analysis component 204 may then train the one or more ML models for the various layers. Each layer 208 can have one or more ML models associated therewith. Each ML model may be different and use different information to train the ML model. For example, the region identifier model 210 may train on the information within the unstructured document received in step 608. This information or training can include identifying words, phrases, punctuation, or other granular document elements within the document, determining sentiment or other meaning of the words, or determining some structure or association of the words therein. The first ML model can produce an output. The first output from the first ML model can then be used to train the candidate generator model 214 and/or the classifier model 218 associated with layer 208b.

As explained in conjunction with FIG. 5B, the candidate generator model 214 identifies structure associated with the information found by the region identifier model 210 in the unstructured document. Thus, the candidate generator model 214 can look for sentences, paragraphs, lists, tables, etc. There may be other ML models that train on the output from the candidate generator model 214, the classifier model 218, or subsequent ML models. The trained ML models may accomplish or perform the operations as described in conjunction with FIGS. 5A through 5E. The merger ML model 230, of layer 208d, can also create the tree diagram described in conjunction with FIG. 4. Included in constructing the tree diagram is the creation of the nodes, by the relationship parser model 222 and/or the semantic organizer model 226, and the creation of the various associations between those nodes.

The various models are stored in the structure library 120, in step 618. Thus, each model and the association of the model with each layer 208 may be stored in the structure library 120. Storing the models allows for the retrieval, by the document structure service 108, of the models for each of the layers 208 to conduct analysis and provide structure for subsequent documents. The document structure service 108 can also associate the models with the various structures and link those models together, in step 620. For example, the document structure service 108 can assign metadata or information about the models that indicate which models to be used to analyze the unstructured document to produce higher level structures or identify the structures in the layers 208. Outputs from a previous model are input into a subsequent model, which can require linking these various ML models together. In this way, the analysis of the document is multilayered with a set of ML models that are chained together to produce a final tree diagram based on the progressive analysis of the several steps performed by the two or more ML models.

A method 700, as conducted by the document structure service 108, for determining the structure of an unstructured document may be as shown in FIG. 7. A general order for the steps of the method 700 is shown in FIG. 7. Generally, the method 700 starts with a start operation 704 and ends with an end operation 732. The method 700 can include more or fewer steps or can arrange the order of the steps differently than those shown in FIG. 7. The method 700 can be executed as a set of computer-executable instructions executed by a computer system and encoded or stored on a computer readable medium. Further, the method 700 can be performed by gates or circuits associated with a processor, an ASIC, a FPGA, a SOC, or other hardware device. Hereinafter, the method 700 shall be explained with reference to the systems, components, devices, modules, software, data structures, interfaces, methods, etc. described in conjunction with FIGS. 1-6 and 8-11.

The document structure service 108 can receive an unstructured document, in step 708. The unstructured document may be provided by client 112, received from a third-party or other source, retrieved from a database, etc. The unstructured document may then be presented to the first layer 208A.

The region identifier model 210, associated with the first layer 208a, may then determine structures or other granular data within the unstructured document, in step 712. Thus, the region identifier model 210, in layer 208a, can conduct the analysis as described in conjunction with FIG. 5A. The subsequent first output, from the region identifier model 210, may be provided to the next layer 208b, in step 716. This first output can be an identification of the words, phrases, punctuation, etc. within the unstructured document, as described in conjunction with 5 A.

Document structure service 108 may then provide this first output information to layer 2 208b. The candidate generator model 214 may then determine sentences 502a, 502b, paragraphs or other candidate structures, based on the words 504, phrases 506, etc. provided in the output from the first layer 208a. The identified structures from the candidate generator model 214 can then be provided to the classifier model 218. The classifier model 218 can indicated the type of structure identified by the candidate generator model 214. For example, the classifier model 218 can classify sentences, paragraphs, tables, lists, captions, endnotes, footnotes, etc. The classified and identified structures then form the output from layer 2 208b. The output from layer 2 208b may then be provided to layer 3 208c for layer 3 208c to identify the relationships between the structural elements as described in conjunction with FIG. 5C.

Each layer may subsequently build on the structures and outputs of previously layers 208. As described in FIGS. 5A-5E, the layers 208 conduct an analysis to generate information about the structure of the document. Each layer's output provides an input into the next layer 208. This chained or multilayer analysis continues until final layer 208n. Thus, the document structure service 108 continues to execute the semantic analysis component 204, with the various ML models, until a last layer 208n, as determined in step 720. If there is no more layers, the method 700 proceeds YES to step 724. However, if there is another layer, the method 700 proceeds NO back to step 720 to conduct other structural analysis with a different layer, in step 712.

In step 724, the semantic organizer 226 and merger 230 can develop the tree nodes 404-420, as described in conjunction with FIG. 4. The tree nodes 404-420, can be the output of the highest level structures from the previous layers 208, as described in conjunction with FIGS. 5A and 5E. The tree nodes 404-420 indicate each different element or structure from paragraphs and lists to the words and data produced by the first layer 208a to the last layer 208n, as described in conjunction with FIGS. 5A to 5E.

The last layer 208d /208n can then develop the tree diagram representing the document structure by indicating where the nodes are within the tree diagram and putting the various braches together in an order, in step 728. For example, layer 208d can produce a tree diagram 400 with child and parent nodes to indicate location and relationship of the different nodes and representative structures. The child node, which may be a lower level structure, may be subordinate to a higher parent node, as described in conjunction FIG. 4. The tree diagram 400 then indicates the structure of the document and can be provided as a tree graph to other applications.

FIG. 8 is a block diagram illustrating physical components (e.g., hardware) of a computing device 800 with which aspects of the disclosure may be practiced. The computing device components described below may be suitable for the computing devices described above. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805and one or more program modules 806 suitable for performing the various aspects disclosed herein. The operating system 805, for example, may be suitable for controlling the operation of the computing device 800. Furthermore, aspects of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., application 820) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 880. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

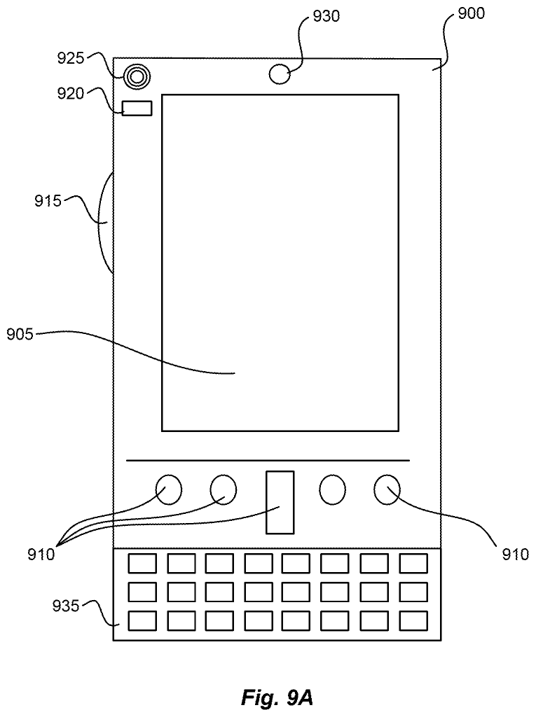

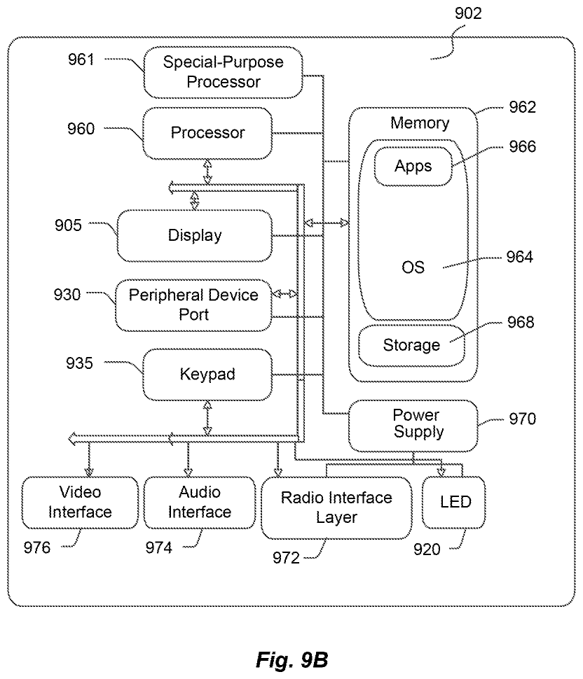

FIGS. 9A and 9B illustrate a computing device or mobile computing device 900, for example, a mobile telephone, a smart phone, wearable computer (such as a smart watch), a tablet computer, a laptop computer, and the like, with which aspects of the disclosure may be practiced. In some aspects, the client (e.g., computing system 108, 112) may be a mobile computing device. With reference to FIG. 9A, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the client to enter information into the mobile computing device 900. The display 905 of the mobile computing device 900 may also function as an input device (e.g., a touch screen display). If included, an optional side input element 915 allows further client input. The side input element 915 may be a rotary switch, a button, or any other type of manual input element. In alternative aspects, mobile computing device 900 may incorporate more or less input elements. For example, the display 905 may not be a touch screen in some aspects. In yet another alternative aspect, the mobile computing device 900 is a portable phone system, such as a cellular phone. The mobile computing device 900 may also include an optional keypad 935. Optional keypad 935 may be a physical keypad or a “soft” keypad generated on the touch screen display. In various aspects, the output elements include the display 905 for showing a graphical client interface (GUI), a visual indicator 920 (e.g., a light emitting diode), and/or an audio transducer 925 (e.g., a speaker). In some aspects, the mobile computing device 900 incorporates a vibration transducer for providing the client with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one aspect of computing device, a server (e.g., server 108), or a mobile computing device. That is, the computing device 900 can incorporate a system (e.g., an architecture) 902 to implement some aspects. The system 902 can implemented as a “smart phone” capable of running one or more applications (e.g., browser, e-mail, calendaring, contact managers, messaging clients, games, and media clients/players). In some aspects, the system 902 is integrated as a computing device, such as document structure service server, client, and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900 described herein (e.g., search engine, extractor module, relevancy ranking module, answer scoring module, etc.).

The system 902 has a power supply 970, which may be implemented as one or more batteries. The power supply 970 might further include an external power source, such as an alternating current (AC) adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 920 may be used to provide visual notifications, and/or an audio interface 974 may be used for producing audible notifications via the audio transducer 925. In the illustrated configuration, the visual indicator 920 is a light emitting diode (LED) and the audio transducer 925 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the client takes action to indicate the powered-on status of the device. The audio interface 974 is used to provide audible signals to and receive audible signals from the client. For example, in addition to being coupled to the audio transducer 925, the audio interface 974 may also be coupled to a microphone to receive audible input, such as to facilitate a telephone conversation. In accordance with aspects of the present disclosure, the microphone may also serve as an audio sensor to facilitate control of notifications, as will be described below. The system 902 may further include a video interface 976 that enables an operation of an on-board camera 930 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9B by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 972 or via a distributed computing network. Similarly, such data/information may be readily transferred between computing devices for storage and use according to well-known data/information transfer and storage means, including electronic mail and collaborative data/information sharing systems.

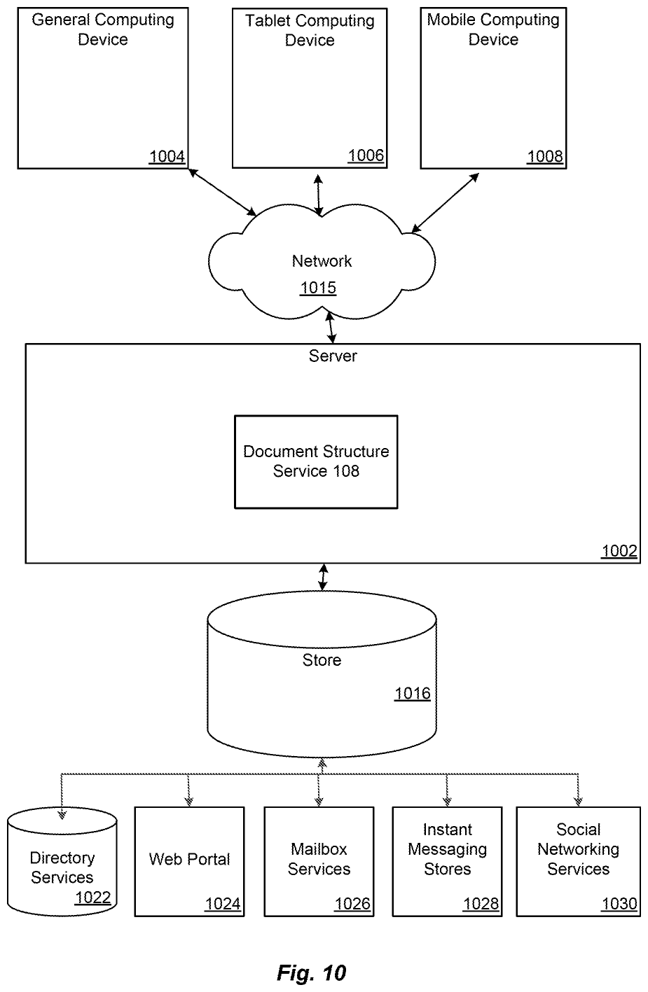

FIG. 10 illustrates one aspect of the architecture of a system for processing data received at a computing system from a remote source, such as a personal computer 1004, tablet computing device 1006, or mobile computing device 1008, as described above. Document displayed at server device 1002 may be stored in different communication channels or other storage types. For example, various documents may be stored using a directory service 1022, a web portal 1024, a mailbox service 1026, an instant messaging store 1028, or a social networking site 1030. Unified profile application programming interface (API) 1021 may be employed by a client that communicates with server device 1002, and/or attribute inference processor 1020 may be employed by server device 1002. The server device 1002 may provide data to and from a client computing device such as a personal computer 1004, a tablet computing device 1006 and/or a mobile computing device 1008 (e.g., a smart phone) through a network 1015. By way of example, the computer system described above may be embodied in a personal computer 1004, a tablet computing device 1006 and/or a mobile computing device 1008 (e.g., a smart phone). Any of these configurations of the computing devices may obtain document from the store 1016, in addition to receiving graphical data useable to be either pre-processed at a graphic-originating system, or post-processed at a receiving computing system.

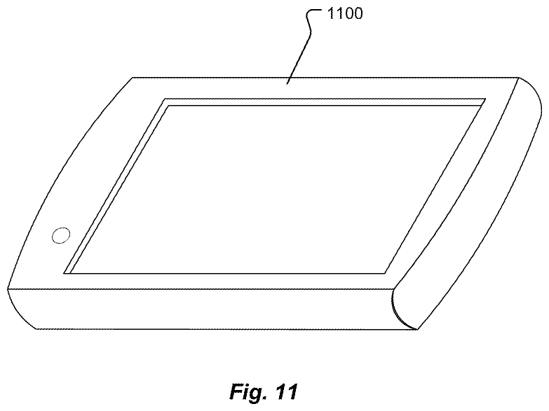

FIG. 11 illustrates an exemplary tablet computing device 1100 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The technical advantage of the system is to produce a more efficient and effective service to determine structure in documents that do not include a document structure file (e.g., the metadata that defines paragraphs, lists, tables, etc., within the document). The multiple-layered system, with multiple ML models, executes more effectively to determine structures and to overcome the disadvantages of past systems—the ability to locate and define tables, defines structures that cross pages, etc. Further, the ML models are easier to train and are less cumbersome as the evaluation of the unstructured document is parsed into several consecutive steps.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure include a method comprising: receiving, at a server, a document without a document structure file describing a document structure for the document; evaluating the document to determine, with a first machine learning (ML) model, a presence of two or more of a paragraph, a list, a table, a sentence, a word, a punctuation, a space, a page break, and a phrase; determining, with a second ML model, a relationship between two or more of the paragraph, the list, the table, the sentence, the word, the punctuation, the space, the page break, and the phrase; based on the presence and the relationship, generating the document structure file describing the document structure; and providing the document structure file to another application to facilitate processing with the other application.

Any of the one or more above aspects, wherein evaluating the document further comprises determining the presence of one or more other elements.

Any of the one or more above aspects, wherein the one or more other elements comprises one or more of a hyperlink, a multimedia object, a chart, a graph, a caption, a link, or a pointer.

Any of the one or more above aspects, wherein a third ML model evaluates the document to determine the presence of two or more of the word, the punctuation, the space, or the page break, and wherein the output of the third ML model is provided to the first ML model to determine the presence of two or more of the paragraph, the list, the table, the sentence.

Any of the one or more above aspects, wherein a fourth ML model creates the document structure file.

Any of the one or more above aspects, wherein the document structure file is a tree diagram comprising two or more nodes, wherein a first node represents a first paragraph, list, table, sentence, word, punctuation, space, page break, or phrase, and a second node represents a second paragraph, list, table, sentence, word, punctuation, space, page break, or phrase.

Any of the one or more above aspects, wherein the first node is a child node of the second node.

Any of the one or more above aspects, wherein a first layer applies the first ML model to the document, and wherein a second layer applies the second ML model to an output of the first ML model.

Any of the one or more above aspects, wherein the second ML model also determines a location of the two or more of the paragraph, the list, the table, the sentence, the word, the punctuation, the space, the page break, and the phrase.

Any of the one or more above aspects, wherein the first ML model is trained on at least one other document, and wherein the second ML model is trained on at least one other output from the first ML model.

Aspects of the present disclosure include a computer storage media having stored thereon computer-executable instructions that when executed by a processor cause the processor to perform a method, the method comprising: receiving a document at a document structure service; training a first machine learning (ML) model on the document to determine a presence, in the document, of two or more elements; training a second ML model to determine a relationship between the two or more elements; and based on the presence and the relationship, training a third ML model to generate a document structure file describing a document structure for the document, wherein the document structure file is an electronic file provided to another application to facilitate processing with the other application.

Any of the one or more above aspects, further comprising: receiving a second document without the document structure file; evaluating the second document to determine, with the first ML model, the presence of the two or more elements; determining, with the second ML model, the relationship between the two or more elements; based on the presence and the relationship, generating, with the third ML model, the document structure file; and providing the document structure file to the other application to facilitate processing with the other application.

Any of the one or more above aspects, wherein the two or more elements comprise two or more of a presence of two or more of a paragraph, a list, a table, a sentence, a word, a punctuation, a space, a page break, and a phrase.

Any of the one or more above aspects, wherein the two or more elements comprise one or more of a hyperlink, a multimedia object, a chart, a graph, a caption, a link, or a pointer.

Any of the one or more above aspects, wherein the document structure file is a tree diagram comprising two or more nodes, wherein a first node represents a first paragraph, list, table, sentence, word, punctuation, space, page break, or phrase, and a second node represents a second paragraph, list, table, sentence, word, punctuation, space, page break, or phrase.

Aspects of the present disclosure include a server comprising: a memory having stored thereon computer-executable instructions; and a processor, in communication the memory, to execute the computer-executable instructions to perform a method comprising: receiving a document at a document structure service; training a first machine learning (ML) model on the document to determine a presence, in the document, of two or more elements; training a second ML model to determine a relationship between the two or more elements; based on the presence and the relationship, training a third ML model to generate a document structure file describing a document structure for the document, wherein the document structure file is an electronic file provided to another application to facilitate processing with the other application; receiving a second document without the document structure file; evaluating the second document to determine, with the first ML model, the presence of the two or more elements; determining, with the second ML model, the relationship between the two or more elements; based on the presence and the relationship, generating, with the third ML model, the document structure file; and providing the document structure file to the other application to facilitate processing with the other application.

Any of the one or more above aspects, wherein the two or more elements comprise two or more of a presence of two or more of a paragraph, a list, a table, a sentence, a word, a punctuation, a space, a page break, and a phrase.

Any of the one or more above aspects, wherein the two or more elements comprise one or more of a hyperlink, a multimedia object, a chart, a graph, a caption, a link, or a pointer.

Any of the one or more above aspects, wherein the document structure file is a tree diagram comprising two or more nodes.

Any of the one or more above aspects, wherein a first node represents a first paragraph, list, table, sentence, word, punctuation, space, page break, or phrase, and a second node represents a second paragraph, list, table, sentence, word, punctuation, space, page break, or phrase, and wherein a location of the first node in relation to the second node indicates the relationship between the first node and the second node.

Any one or more of the aspects as substantially disclosed herein.

Any one or more of the aspects in combination with any one or more other aspects as substantially disclosed herein.

One or means adapted to perform any one or more of the above aspects as substantially disclosed herein.

What is claimed is:

1. A method comprising:
receiving, at a server, a document without a document structure file describing a document structure for the document;
evaluating the document to determine, with a first machine learning (ML) model, a presence of two or more of a paragraph, a list, a table, a sentence, a word, a punctuation, a space, a page break, and a phrase;
determining, with a second ML model, a relationship between two or more of the paragraph, the list, the table, the sentence, the word, the punctuation, the space, the page break, and the phrase;
based on the presence and the relationship, generating the document structure file describing the document structure; and
providing the document structure file to another application to facilitate processing with the other application.

2. The method of claim 1, wherein evaluating the document further comprises determining the presence of one or more other elements.

3. The method of claim 2, wherein the one or more other elements comprises one or more of a hyperlink, a multimedia object, a chart, a graph, a caption, a link, or a pointer.

4. The method of claim 1, wherein a third ML model evaluates the document to determine the presence of two or more of the word, the punctuation, the space, or the page break, and wherein the output of the third ML model is provided to the first ML model to determine the presence of two or more of the paragraph, the list, the table, the sentence.

5. The method of claim 4, wherein a fourth ML model creates the document structure file.

6. The method of claim 1, wherein the document structure file is a tree diagram comprising two or more nodes, wherein a first node represents a first paragraph, list, table, sentence, word, punctuation, space, page break, or phrase, and a second node represents a second paragraph, list, table, sentence, word, punctuation, space, page break, or phrase.

7. The method of claim 6, wherein the first node is a child node of the second node.

8. The method of claim 1, wherein a first layer applies the first ML model to the document, and wherein a second layer applies the second ML model to an output of the first ML model.

9. The method of claim 8, wherein the second ML model also determines a location of the two or more of the paragraph, the list, the table, the sentence, the word, the punctuation, the space, the page break, and the phrase.

10. The method of claim 8, wherein the first ML model is trained on at least one other document, and wherein the second ML model is trained on at least one other output from the first ML model.

11. A computer storage media having stored thereon computer-executable instructions that when executed by a processor cause the processor to perform a method, the method comprising:
receiving a document at a document structure service;
training a first machine learning (ML) model on the document to determine a presence, in the document, of two or more elements;
training a second ML model to determine a relationship between the two or more elements; and
based on the presence and the relationship, training a third ML model to generate a document structure file describing a document structure for the document, wherein the document structure file is an electronic file provided to another application to facilitate processing with the other application.

12. The computer storage media of claim 11, further comprising:
receiving a second document without the document structure file;
evaluating the second document to determine, with the first ML model, the presence of the two or more elements;
determining, with the second ML model, the relationship between the two or more elements;
based on the presence and the relationship, generating, with the third ML model, the document structure file; and
providing the document structure file to the other application to facilitate processing with the other application.

13. The computer storage media of claim 11, wherein the two or more elements comprise two or more of a presence of two or more of a paragraph, a list, a table, a sentence, a word, a punctuation, a space, a page break, and a phrase.

14. The computer storage media of claim 13, wherein the two or more elements comprise one or more of a hyperlink, a multimedia object, a chart, a graph, a caption, a link, or a pointer.

15. The computer storage media of claim 11, wherein the document structure file is a tree diagram comprising two or more nodes, wherein a first node represents a first paragraph, list, table, sentence, word, punctuation, space, page break, or phrase, and a second node represents a second paragraph, list, table, sentence, word, punctuation, space, page break, or phrase.

16. A server comprising:
a memory having stored thereon computer-executable instructions; and
a processor, in communication the memory, to execute the computer-executable instructions to perform a method comprising:
receiving a document at a document structure service;
training a first machine learning (ML) model on the document to determine a presence, in the document, of two or more elements;
training a second ML model to determine a relationship between the two or more elements;
based on the presence and the relationship, training a third ML model to generate a document structure file describing a document structure for the document, wherein the document structure file is an electronic file provided to another application to facilitate processing with the other application;
receiving a second document without the document structure file;
evaluating the second document to determine, with the first ML model, the presence of the two or more elements;
determining, with the second ML model, the relationship between the two or more elements;
based on the presence and the relationship, generating, with the third ML model, the document structure file; and
providing the document structure file to the other application to facilitate processing with the other application.

17. The server of claim 16, wherein the two or more elements comprise two or more of a presence of two or more of a paragraph, a list, a table, a sentence, a word, a punctuation, a space, a page break, and a phrase.

18. The server of claim 17, wherein the two or more elements comprise one or more of a hyperlink, a multimedia object, a chart, a graph, a caption, a link, or a pointer.

19. The server of claim 16, wherein the document structure file is a tree diagram comprising two or more nodes.

20. The server of claim 19, wherein a first node represents a first paragraph, list, table, sentence, word, punctuation, space, page break, or phrase, and a second node represents a second paragraph, list, table, sentence, word, punctuation, space, page break, or phrase, and wherein a location of the first node in relation to the second node indicates the relationship between the first node and the second node.
